(19) United States
(12) Patent Application Publication
(10) Pub. No.: US 2024/0403525 A1
(43) Pub. Date: Dec. 5, 2024

(54) OPERATION VERIFICATION SYSTEM AND OPERATION VERIFICATION DEVICE

(71) Applicant: Mitsubishi Electric Software Corporation, Tokyo (JP)

(72) Inventor: Tadaaki SHIRAISHI, Tokyo (JP)

(73) Assignee: Mitsubishi Electric Software Corporation, Tokyo (JP)

(21) Appl. No.: 18/697,383

(22) PCT Filed: Jul. 8, 2022
(86) PCT No.: PCT/JP2022/027078

§ 371 Date: Mar. 29, 2024

(30) Foreign Application Priority Data
Dec. 28, 2021 (JP) 2021-214375
Feb. 25, 2022 (JP) 2022-027411

(51) Int. Cl. G06F 30/3308; G06F 30/34

(52) U.S. Cl. CPC G06F 30/3308; G06F 30/34

(57) ABSTRACT

An operation verification system and an operation verification device include a computer having installed therein a simulator which simulates a circuit. A control unit which controls an FPGA by a computer includes an operation instruction unit for operating the circuit and the simulator, and a comparison unit which compares a node value of the FPGA when the circuit is operated, obtained from an external memory in which the node value is written from an internal RAM via a bus circuit, and an internal state value corresponding to the node value, to verify operation of the FPGA. The operation instruction unit operates the circuit and the simulator at the same time.

### TECHNICAL FIELD

The present disclosure relates to an operation verification system and an operation verification device.

### BACKGROUND ART

Conventionally, designing quality assurance for semiconductor circuits such as a field-programmable gate array (FPGA) is performed through, for example, hardware description language (HDL) simulation (see, for example, Patent Document 1). The FPGA can implement the function of a designed circuit by programming designed circuit data (see, for example, Patent Document 2).

### CITATION LIST

### Patent Document

Patent Document 1: Japanese Laid-Open Patent Publication (translation of PCT application) No. 2003-503791
Patent Document 2: Japanese Laid-Open Patent Publication No. 2000-122890

### SUMMARY OF THE INVENTION

### Problem to be Solved by the Invention

The HDL simulation is easy to introduce as a tool. However, the HDL simulation takes time for execution of simulation and thus has a problem of taking several hours for about ten thousand cycles, depending on a circuit scale. Therefore, there is a problem that verification cannot be sufficiently performed, leading to malfunction. An application specific integrated circuit (ASIC) emulator can perform full-node observation and thus has a high detection rate for malfunction. However, a memory and/or an interface does not operate at the actual speed and it is difficult to perform verification application for a high-speed-operation peripheral. In addition, the execution speed of verification is as slow as not higher than ⅕ of the actual operation speed, and the cost is extremely high above several tens of millions of yen.

An object of the present disclosure is to provide an operation verification system and an operation verification device that can complete verification in several minutes or less even if the verification takes more than ten million cycles.

### Means to Solve the Problem

An operation verification system according to one aspect of the present disclosure includes: an FPGA having a circuit programmed therein; an internal random access memory (RAM) of the FPGA; a bus circuit interposed for transmission and reception of data between the internal RAM and outside; an external memory in which a node value of the FPGA is written from the internalRAM via the bus circuit; a computer having installed therein a simulator which simulates the circuit; and a communication path connecting the FPGA and the computer via the bus circuit. The computer includes a system memory in which an internal state value when the simulator is operated is written, and a control unit which controls the FPGA via the communication path. The control unit includes an operation instruction unit for operating the circuit and the simulator, and a comparison unit which compares the node value when the circuit is operated and the internal state value corresponding to the node value, to verify operation of the FPGA. The operation instruction unit operates the circuit and the simulator at the same time.

### Effect of the Invention

In the operation verification system according to the one aspect of the present disclosure, the control unit operates the circuit and the simulator at the same time, and compares a node value when the circuit is operated and an internal state value corresponding to the node value, to perform circuit verification. Thus, it is possible to complete verification in several minutes or less even if the verification takes more than ten million cycles.

### BRIEF DESCRIPTION OF THE DRAWINGS

FIG. 1 shows the configurations of an operation verification system and an operation verification device according to embodiment 1.

FIG. 2 shows a preferable example of an operation instruction unit shown in FIG. 1.

FIG. 3 is a flowchart showing a first example of operation of the operation verification system and the operation verification device shown in FIG. 1.

FIG. 4 is a flowchart showing a second example of operation of the operation verification system and the operation verification device shown in FIG. 1.

FIG. 5 shows state transition of the operation verification system and the operation verification device shown in FIG. 1.

FIG. 6 shows state transition of the operation verification system and the operation verification device shown in FIG. 1.

FIG. 7 shows an example of a hardware configuration for implementing the functions of a simulator and a control unit shown in FIG. 1.

FIG. 8 shows the configuration of an operation verification system and an operation verification device according to embodiment 2.

FIG. 9 is a flow diagram showing a co-design system using an operation verification system and an operation verification device according to embodiment 3.

### DESCRIPTION OF EMBODIMENTS

### Embodiment 1

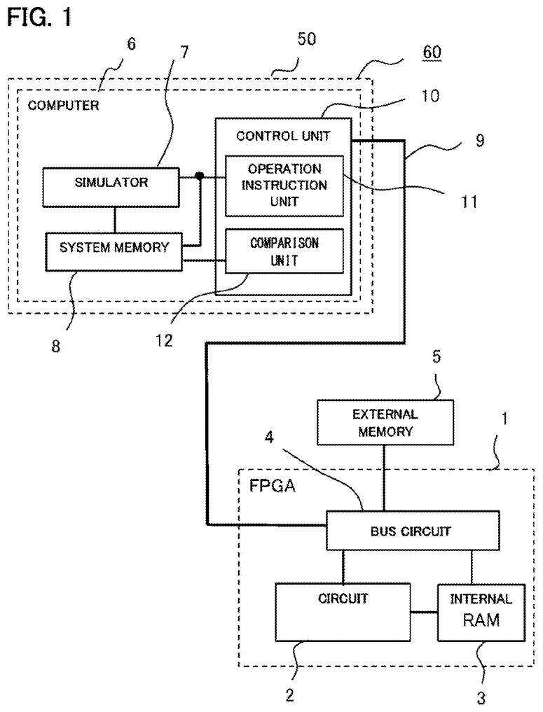

Hereinafter, an operation verification system and an operation verification device according to embodiment 1 will be described with reference to FIG. 1 to FIG. 7. In the drawings, the same reference characters denote the same or corresponding parts and the detailed description thereof is omitted.

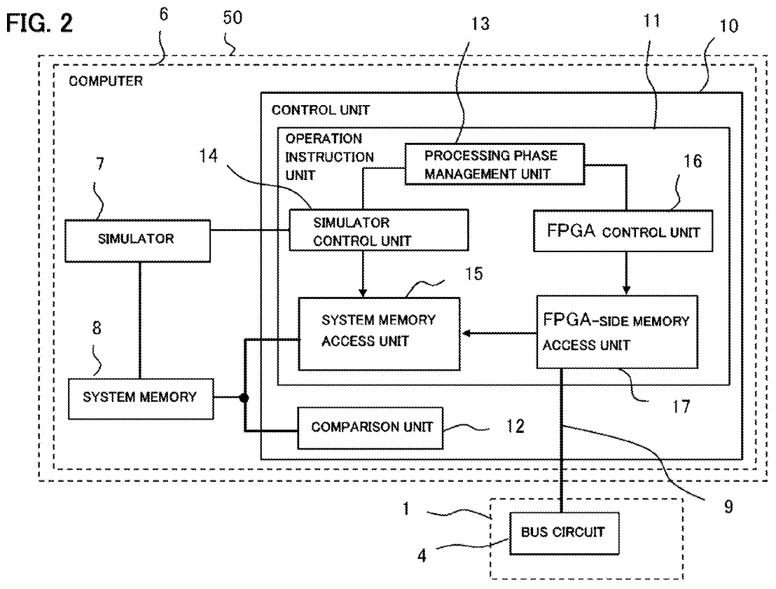

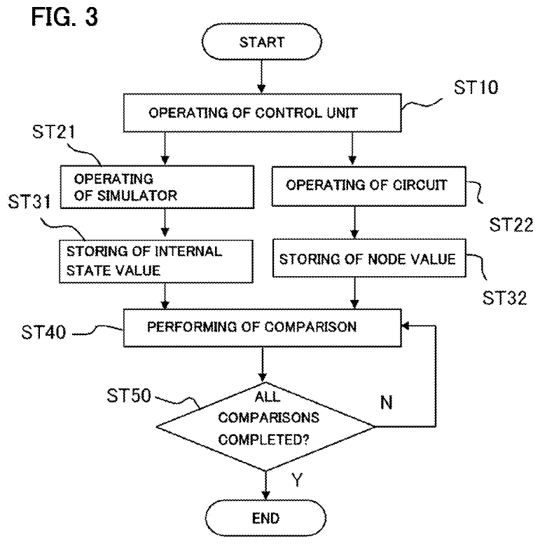

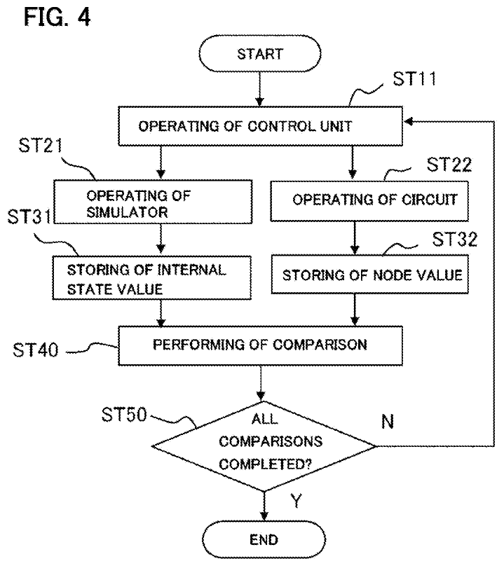

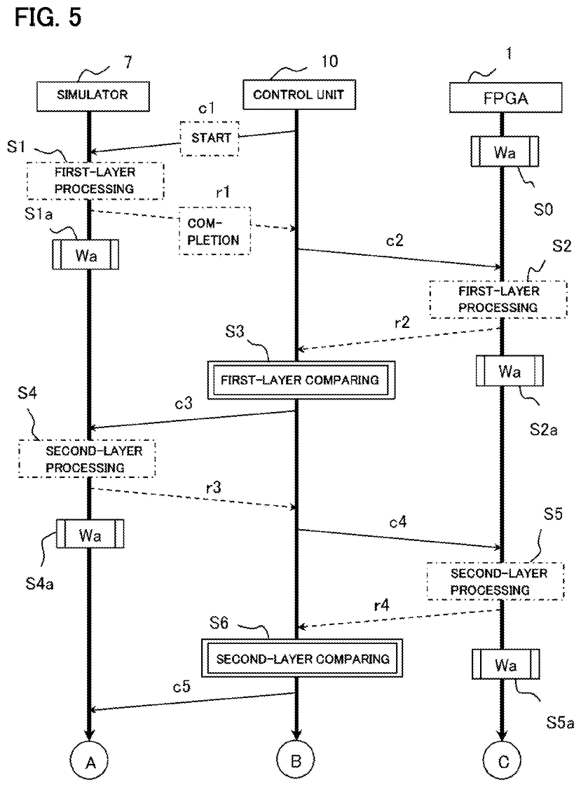

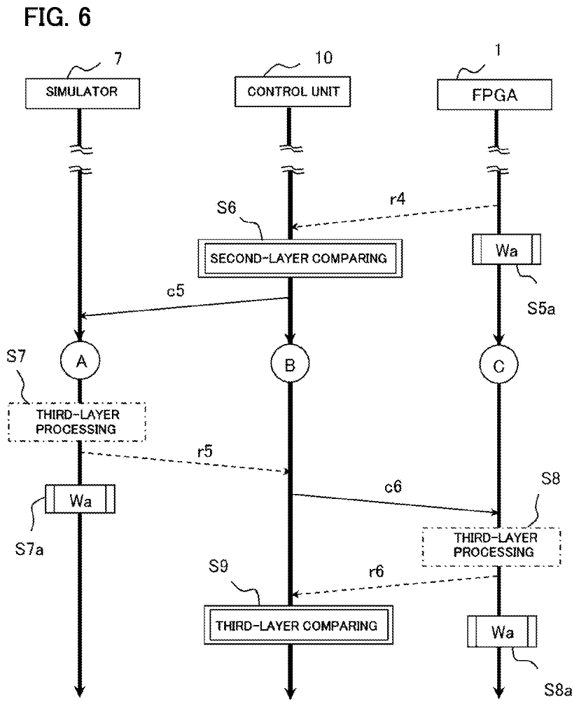

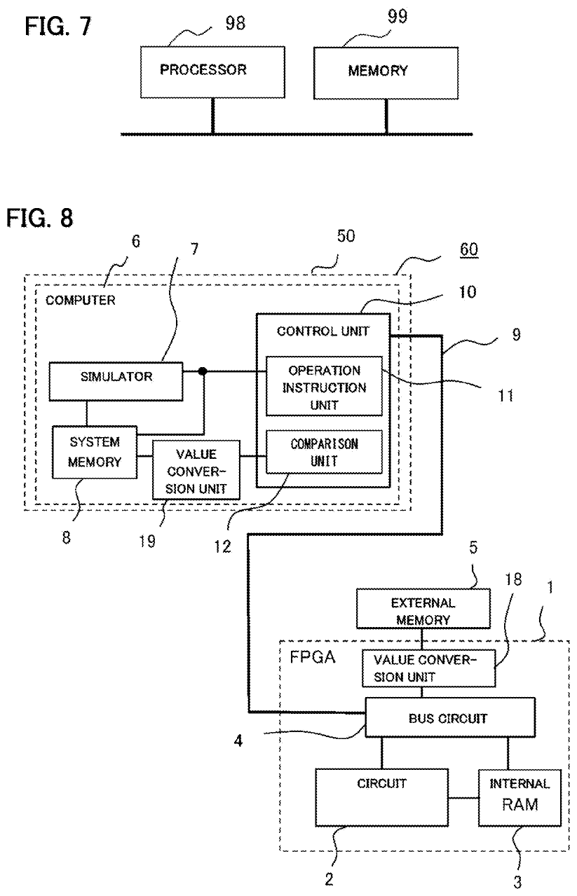

FIG. 1 shows the configurations of the operation verification system and the operation verification device according to embodiment 1, and FIG. 2 shows a preferable example of an operation instruction unit shown in FIG. 1. FIG. 3 is a flowchart showing a first example of operation of the operation verification system and the operation verification device shown in FIG. 1, and FIG. 4 is a flowchart showing a second example of operation of the operation verification system and the operation verification device shown in FIG. 1. FIG. 5 and FIG. 6 show state transition of the operation verification system and the operation verification device shown in FIG. 1. FIG. 7 shows an example of a hardware configuration for implementing the functions of a simulator and a control unit shown in FIG. 1. An operation verification system 60 according to embodiment 1 includes an operation verification device 50, an FPGA 1 which is an example of a semiconductor circuit and has a circuit 2 as an operation verification target, and an external memory 5 connected to the FPGA 1. In FIG. 1, the operation verification device 50 is implemented by a computer 6, as an example.

In FIG. 1, the FPGA 1 has programmed therein the circuit 2 which is an operation verification target. The internal RAM 3 is an internal RAM formed in a built-in memory block of the FPGA 1. A bus circuit 4 is interposed for transmission and reception of data between the internal RAM 3 and the outside. In the external memory 5, a node value of the FPGA 1 is written from the internal RAM 3 via the bus circuit 4. Preferably, the external memory 5 is a double data rate (DDR) memory or the like. A communication path 9 connects the FPGA 1 and the computer 6 via the bus circuit 4. Preferably, the communication path 9 establishes ultra-high-speed connection using USB (registered trademark) 3.x, PCI-Express (registered trademark), or the like. The bus circuit 4 is formed by custom bus designing that allows access to a register, a memory block, and the like on the FPGA 1 side directly from the computer 6. Preferably, a control circuit is provided also on the FPGA 1 side, i.e., an FPGA 1-side control circuit is provided.

A node and a node value will be described. A specific one, of internal circuits, that is connected to an external circuit is referred to as a specific internal circuit. Unlike an output of the specific internal circuit connected to the external circuit, outputs of internal circuits other than the specific internal circuit are normally not outputted to the outside. Here, the internal circuits other than the specific internal circuit are referred to as nodes, and the state values of the nodes are referred to as node values.

The operation verification device 50 according to embodiment 1 corresponds to the computer 6. Preferably, the computer 6 is a general personal computer (PC), a general workstation, or the like. The computer 6 may be implemented by a microcomputer formed in a product on which the FPGA 1 is mounted, or may be implemented by a microcomputer formed inside the FPGA 1. In FIG. 1, the computer 6 has installed therein a simulator 7 which simulates the circuit 2. Specifically, a unit in which the simulator 7 simulating the function of the circuit 2 is installed corresponds to the computer 6. On the basis of software requirement specifications, the circuit 2 and the simulator 7 are each formed, and as a result, the simulator 7 means a simulator which simulates the circuit 2. Therefore, it can be said that the simulator 7 which simulates the circuit 2 is abbreviation of a simulator which simulates the function of the circuit 2. In a system memory 8, an internal state value when the computer 6 operates the simulator 7 is written. A control unit 10 controls the FPGA 1 by the computer 6 via the communication path 9. The control unit 10 includes an operation instruction unit 11 and a comparison unit 12. The operation instruction unit 11 is for operating the circuit 2 and the simulator 7. The comparison unit 12 compares a node value when the circuit 2 is operated and an internal state value corresponding to the node value, to verify operation of the FPGA 1, i.e., operation of the circuit 2.

FIG. 2 shows a preferable function block of the operation instruction unit 11 of the operation verification device 50 according to embodiment 1. FIG. 2 shows a preferable example of the detailed configuration of the operation instruction unit 11 shown in FIG. 1. The operation instruction unit 11 includes a processing phase management unit 13, a simulator control unit 14, a system memory access unit 15, an FPGA control unit 16, and an FPGA-side memory access unit 17. The processing phase management unit 13 manages processing phases of the operation instruction unit 11. When operating the circuit 2, in the operation instruction unit 11, the processing phase management unit 13 controls the FPGA control unit 16, and the FPGA-side memory access unit 17 starts and operates the circuit 2 of the FPGA 1 via the communication path 9. When operating the simulator 7, in the operation instruction unit 11, the processing phase management unit 13 controls the simulator control unit 14 to start and operate the simulator 7. The simulator control unit 14 also accesses the system memory 8 via the system memory access unit 15. In addition, the FPGA-side memory access unit 17 accesses the system memory 8 via the system memory access unit 15.

In the operation verification system 60 and the operation verification device 50 according to embodiment 1, comparison by the comparison unit 12 is performed on a memory basis, but values may be loaded as a file if necessary. Specifically, the comparison unit 12 can compare a node value and an internal state value on a memory basis between the external memory 5 and the system memory 8. As a matter of course, the comparison unit 12 can also compare a node value and an internal state value between files outputted from the system memory 8 and the external memory 5.

In the operation verification system 60 and the operation verification device 50 according to embodiment 1, operation verification software for performing host control of the simulator 7 may be developed and a specific method for comparison with the FPGA 1 may be defined and executed. It can be said that the operation verification software for performing host control of the simulator 7 is incorporated in the control unit 10. The control unit 10 including the operation instruction unit 11 and the comparison unit 12 may have a debug function for stopping operation of the FPGA 1 at a designated position and confirming the internal state, whereby analysis efficiency can be improved. That is, the comparison unit 12 compares a designated node value and the corresponding internal state value.

In order to enable control operation of the control unit 10 including the operation instruction unit 11 and the comparison unit 12 as described above, it is preferable that the aforementioned FPGA 1-side control circuit is incorporated on the FPGA 1 side. For avoiding confusion, the control unit 10 and/or the FPGA 1-side control circuit may be standardized and rules may be established therefor, whereby versatility is improved. Further, the operation instruction unit 11 can perform real operation verification by operating the circuit 2 and the simulator 7 at the same time. Thus, a test including several hundreds of millions of cycles can be finished in several seconds.

In a case where the circuit 2 which is an operation verification target is an object detection artificial intelligence (AI) such as You only Look once (YoLo), calculation needs to be performed more than one hundred million times for one image. A data set in the international standard includes more than twenty thousand images. In a case where an AI algorithm code described and evaluated by Python, TensorFlow, or the like is implemented on a circuit such as an FPGA, a problem is to what degree the functional equivalence can be confirmed in detail. Ideally, it is desirable that verification for one hundred million cycles×twenty thousand images is confirmed for all convolution results in the FPGA 1. The operation verification system 60 and the operation verification device 50 according to embodiment 1 can make it feasible to achieve such a desirable condition. That is, this can be achieved by performing operations with the computer 6 as a master and the FPGA 1 as a slave at the actual speed, operating the simulator 7 and the FPGA 1 at the same time, and sequentially performing comparison about difference between their operations. The computer 6 and the FPGA 1 are connected in a high-speed manner using USB3.x or the like. For example, in a case of operating the FPGA 1 at 100 MHz, operation is performed at one hundred million cycles per second.

Next, an operation verification method according to embodiment 1, i.e., operation of the operation verification system 60 and the operation verification device 50 according to embodiment 1 shown in FIG. 1, will be described with reference to FIG. 3 and FIG. 4. In FIG. 3 and FIG. 4, step ST10 is a processing step of starting and operating the control unit 10 including the operation instruction unit 11 and the comparison unit 12, in order to perform operation verification for the circuit 2 of the FPGA 1. That is, step ST10 is a step in which the control unit 10 operates. In a case of FIG. 4, the first step is step ST11. In step ST11, the control unit 10 operates while accompanied with state transition of operation verification as described later. Step ST21 is a processing step in which the operation instruction unit 11 starts and operates the simulator 7. In step ST21, the simulator 7 operates. Step ST22 is a processing step in which the operation instruction unit 11 starts and operates the circuit 2 of the FPGA 1. In step ST22, the circuit 2 of the FPGA 1 operates. For this operation, the aforementioned FPGA 1-side control circuit may be used. Step ST31 is a processing step in which the system memory 8 sequentially stores internal state values. Step ST32 is a processing step in which the internal RAM 3 sequentially stores node values and the external memory 5 sequentially acquires and stores the node values. For this operation, the aforementioned FPGA 1-side control circuit may be used. In FIG. 3 and FIG. 4, step ST40 is a processing step of comparing the node value and the internal state value corresponding to each other, to verify operation of the circuit 2 of the FPGA 1. Step ST50 exemplifies a processing step of comparing all node values and internal state values. That is, step ST50 exemplifies a case of sequentially performing comparison about difference between operations of the simulator 7 and the circuit 2. In FIG. 3, in step ST50, whether or not comparison for all comparison targets has been completed is determined. Then, if comparison for all comparison targets has not been completed, the process proceeds to step ST40, and if comparison for all comparison targets has been completed, the process is ended. In FIG. 4, in step ST50, whether or not comparison for all comparison targets has been completed is determined. Then, if comparison for all comparison targets has not been completed, the process proceeds to step ST11, and if comparison for all comparison targets has been completed, the process is ended. As a matter of course, operation of the circuit 2 of the FPGA 1 may be stopped at a designated position, to confirm the internal state. As described above, the comparison unit 12 compares a designated node value and the corresponding internal state value.

Difference between FIG. 3 and FIG. 4 will be described in a case where the circuit 2 of the FPGA 1 and the simulator 7 are AIs, as an example. FIG. 4 shows a case of stopping the process for each layer. Meanwhile, FIG. 3 shows a case of continuing the process until processing is finished for all layers. That is, the flow in FIG. 3 is an example in which, after operation of the operation verification target is all executed, a node value designated in advance as a node of the operation verification target and the corresponding internal state value are compared. In the flow in FIG. 4, a node value designated in advance as a node of the operation verification target and the corresponding internal state value are compared until a predetermined stop point, e.g., processing for each layer, in operation of the operation verification target. Thereafter, the simulator 7 and the circuit 2 are operated until the next stop point, and the node value designated in advance as the node of the operation verification target and the corresponding internal state value are compared until the present stop point after the previous stop point. That is, the flow in FIG. 4 is an example in which operations of the simulator 7 and the circuit 2 and comparison in step ST40 are repeated until a final point which is the last stop point. The aforementioned state transition of operation verification is transition of the progress state of the stop point.

Also in the operation verification method according to embodiment 1, comparison by the comparison unit 12 is performed on a memory basis, but values may be loaded as a file if necessary. In addition, the operation instruction unit 11 can perform real operation verification by operating the circuit 2 and the simulator 7 at the same time. Thus, a test including several hundreds of millions of cycles can be finished in several seconds.

FIG. 5 and FIG. 6 show state transition of the operation verification system 60 and the operation verification device 50 according to embodiment 1. The state transition shown in FIG. 5 and FIG. 6 is an example corresponding to the flow shown in FIGS. 4. A, B, and C at the end on the downstream side of arrows in FIG. 5 are the same as A, B, and C in FIG. 6, respectively. That is, A, B, and C at the end in FIG. 5 lead to subsequent parts downward of A, B, and C in FIG. 6, respectively. FIG. 5 shows state transition in a case where the circuit 2 of the FPGA 1 and the simulator 7 are AIs, as an example. In this example, processing is performed up to the third layer. The process starts from a start command c1 with which the control unit 10 instructs the simulator 7 to start operation. When the control unit 10 operates the circuit 2 and the simulator 7 at the same time using operation verification software, they exhibit state transition as shown in FIG. 5 and FIG. 6. Appropriately, the circuit 2 of the FPGA 1 may be simply referred to as the circuit 2.

Specifically, in processing for the first layer, the control unit 10 starts and operates the simulator 7, and after the first-layer processing is completed, the control unit 10 stops the simulator 7 once. Next, the control unit 10 starts and operates the circuit 2, and after the first-layer processing is completed, the control unit 10 stops the circuit 2 once. Then, in processing for the second layer and the third layer, similarly, the control unit 10 operates the circuit 2 of the FPGA 1 and the simulator 7. Such operation means that the operation instruction unit 11 operates the circuit 2 and the simulator 7 at the same time. That is, it is not necessary that the circuit 2 and the simulator 7 operate completely at the same time in a temporal sense. The circuit 2 and the simulator 7 operate in parallel through control and instruction by the operation instruction unit 11, and this means that there is surely a time period in which the circuit 2 and the simulator 7 operate at the same time.

More detailed description will be given. States of the circuit 2 of the FPGA 1 and the simulator 7 shown in FIG. 5 and FIG. 6 are denoted by S0, S1, S1a, S2, S2a, S3, S4, S4a, S5, S5a, S6, S7, S7a, S8, S8a, and S9. The states S0, S1a, S2a, S4a, S5a, S7a, and S8a are temporarily stopped states, i.e., waiting states. The states S1 and S2 are states in which the simulator 7 and the circuit 2 respectively perform operations in the first-layer processing. The states S4 and S5 are states in which the simulator 7 and the circuit 2 respectively perform operations in the second-layer processing. The states S7 and S8 are states in which the simulator 7 and the circuit 2 respectively perform operations in the third-layer processing. The states S3, S6, and S9 are states in which the control unit 10 performs operation of comparing the node value of the circuit 2 and the internal state value of the simulator 7 corresponding to the node value, in the comparison unit 12.

The control unit 10 outputs the start command c1 to the simulator 7. The simulator 7 executes processing in the state S1, and outputs a completion report r1 to the control unit 10 after completing the processing. Thereafter, the simulator 7 comes into the state Sla. At this time, the circuit 2 is in the state S0, i.e., awaiting state. Next, the control unit 10 outputs a start command c2 to the circuit 2. The circuit 2 executes processing in the state S2, and outputs a completion report r2 to the control unit 10 after completing the processing. Thereafter, the circuit 2 comes into the state S2a. The control unit 10 executes processing in the state S3. After the comparison processing is completed, the control unit 10 outputs a start command c3 to the simulator 7.

The simulator 7 executes processing in the state S4, and outputs a completion report r3 to the control unit 10 after completing the processing. Thereafter, the simulator 7 comes into the state S4a. Next, the control unit 10 outputs a start command c4 to the circuit 2. The circuit 2 executes processing in the state S5, and outputs a completion report r4 to the control unit 10 after completing the processing. Thereafter, the circuit 2 comes into the state S5a. The control unit 10 executes processing in the state S6. After the comparison processing is completed, the control unit 10 outputs a start command c5 to the simulator 7.

The simulator 7 executes processing in the state S7, and outputs a completion report r5 to the control unit 10 after completing the processing. Thereafter, the simulator 7 comes into the state S7a. Next, the control unit 10 outputs a start command c6 to the circuit 2. The circuit 2 executes processing in the state S8, and outputs a completion report r6 to the control unit 10 after completing the processing. Thereafter, the circuit 2 comes into the state S8a. The control unit 10 executes processing in the state S9. If the third-layer processing is last, in step ST50 in FIG. 4, it is determined that comparison for all comparison targets has been completed, and thus the process is ended. If the third-layer processing is not last, the process returns to step ST11, to repeat processing from step ST11 to step ST50.

The HDL simulation is easy to introduce as a tool and is inexpensive. In the operation verification system 60 and the operation verification device 50 according to embodiment 1, the circuit 2 which is an operation verification target and the simulator 7 which simulates the circuit 2 are operated at the same time using a general computer, and a node value when the circuit 2 is operated and an internal state value corresponding to the node value are compared, to perform circuit verification. Thus, verification can be easily performed at a high speed using a general device. Therefore, the operation verification system 60 and the operation verification device 50 according to embodiment 1 can perform verification at a higher speed as compared to a general device, and at low cost without the need of an expensive device.

In FIG. 1, the example in which the operation verification device 50 is implemented by the computer 6 has been shown. However, the operation verification device 50 may be implemented by means other than the computer 6. In this case, the functions of the simulator 7 and the control unit 10 of the operation verification device 50 may be implemented by a processor 98 and a memory 99 shown in FIG. 7. The simulator 7 and the control unit 10 are implemented by the processor 98 executing a program stored in the memory 99. A plurality of processors 98 and a plurality of memories 99 may cooperate with each other to execute the functions.

The computer 6 includes the processor 98 and the system memory 8 as in FIG. 7, and the functions of the simulator 7 and the control unit 10 are implemented by the processor 98 executing a program stored in the system memory 8.

As described above, the operation verification system 60 according to embodiment 1 includes: the FPGA 1 having the circuit 2 programmed therein; the internal RAM 3 of the FPGA 1; the bus circuit 4 interposed for transmission and reception of data between the internal RAM 3 and the outside; the external memory 5 in which a node value of the FPGA 1 is written from the internal RAM 3 via the bus circuit 4; the computer 6 having installed therein the simulator 7 which simulates the circuit 2; and the communication path 9 connecting the FPGA 1 and the computer 6 via the bus circuit 4. The computer 6 includes the system memory 8 in which an internal state value when the simulator 7 is operated is written, and the control unit 10 which controls the FPGA 1 via the communication path 9. The control unit 10 includes the operation instruction unit 11 for operating the circuit 2 and the simulator 7, and the comparison unit 12 which compares the node value when the circuit 2 is operated and the internal state value corresponding to the node value, to verify operation of the FPGA 1. The operation instruction unit 11 operates the circuit 2 and the simulator 7 at the same time. With this configuration, in the operation verification system 60 according to embodiment 1, the control unit 10 operates the circuit 2 and the simulator 7 at the same time, and compares the node value when the circuit 2 is operated and the internal state value corresponding to the node value, to perform circuit verification. Thus, it is possible to complete verification in several minutes or less even if the verification takes more than ten million cycles.

As described above, the operation verification device 50 according to embodiment 1 is an operation verification device for verifying operation of the FPGA 1 having the circuit 2 programmed therein. The operation verification device 50 includes the computer 6 having installed therein the simulator 7 which simulates the circuit 2. The computer 6 includes the system memory 8 in which an internal state value when the simulator 7 is operated is written, and the control unit 10 which controls the FPGA 1 via the communication path 9 connecting the FPGA 1 and the computer 6 via the bus circuit 4 interposed for transmission and reception of data between the internal RAM 3 of the FPGA 1 and the outside (external memory 5). The control unit 10 includes the operation instruction unit 11 for operating the circuit 2 and the simulator 7, and the comparison unit 12 which compares a node value of the FPGA 1 when the circuit 2 is operated, obtained from the external memory 5 in which the node value is written from the internal RAM 3 via the bus circuit 4, and the internal state value corresponding to the node value, to verify operation of the FPGA 1. The operation instruction unit 11 operates the circuit 2 and the simulator 7 at the same time. With this configuration, in the operation verification device 50 according to embodiment 1, the control unit 10 operates the circuit 2 and the simulator 7 at the same time, and compares the node value when the circuit 2 is operated and the internal state value corresponding to the node value, to perform circuit verification. Thus, it is possible to complete verification in several minutes or less even if the verification takes more than ten million cycles.

In the operation verification device 50 according to embodiment 1, in both of a case where the computer 6 is implemented by a microcomputer formed in a product on which the FPGA 1 is mounted and a case where the computer 6 is implemented by a microcomputer formed inside the FPGA 1, self-diagnosis of operation verification can be performed on the product on which the FPGA 1 is mounted. Even in a case of such a configuration, in operation verification before self-diagnosis, e.g., before product shipping, the computer 6 formed by a general PC, a general workstation, or the like present outside the product may be connected to the FPGA 1 via the communication path 9, to perform operation verification. As a matter of course, also in self-diagnosis of operation verification, the above method may be performed. In a case where the computer 6 is implemented by a microcomputer formed in a product on which the FPGA 1 is mounted, a line connecting the FPGA 1 and the microcomputer corresponds to the communication path 9. In a case where the computer 6 is implemented by a microcomputer formed inside the FPGA 1, a circuit inside the FPGA 1 corresponds to the communication path 9. Therefore, specifically, it can be said that the communication path 9 connecting the FPGA 1 and the computer 6 is a circuit connecting the circuit 2 of the FPGA 1 and the microcomputer of the FPGA 1.

### Embodiment 2

Hereinafter, the operation verification system 60 and the operation verification device 50 according to embodiment 2 will be described with reference to FIG. 8. FIG. 8 shows the configurations of the operation verification system and the operation verification device according to embodiment 2. In the operation verification system 60 and the operation verification device 50 according to embodiment 2, at least one of a value conversion unit 18 or a value conversion unit 19 is formed, unlike the operation verification system and the operation verification device according to embodiment 1. Description of the same parts between embodiment 1 and embodiment 2 is omitted. In the drawings, the same reference characters denote the same or corresponding parts and the detailed description thereof is omitted.

In FIG. 8, the value conversion unit 18 is formed in the FPGA 1 and converts a node value to another format. The value conversion unit 19 is formed in the computer 6 and converts a node value to another format.

The operation verification system 60 and the operation verification device 50 according to embodiment 2 are configured such that the comparison unit 12 can perform comparison using values after conversion according to a format of at least one of a node value or an internal state value. An execution result of the circuit 2 is a node value formed by a series of 1/0 data as memory information. Meanwhile, an execution result of the simulator 7 is an internal state value that is a variable (numerical type) as memory information.

Therefore, on the basis of information about a storage address position, a bit length, and a most significant bit/most significant byte (MSB), the value conversion unit 18 performs format conversion of a node value which is 1/0 data according to the format on the simulator 7 side, whereby comparison can be facilitated. That is, in comparison between the node value and the internal state value with matched numerical types in the comparison unit 12, analysis is facilitated with information about to what degree the values differ from each other, instead of merely confirming whether or not the values match with each other. Similarly, the value conversion unit 19 performs format conversion of the internal state value that is a variable (numerical type) according to 1/0 data, whereby comparison can be facilitated. In particular, matching the formats of the node value and the internal state value with each other can provide values that a human can easily understand. In a case of having both of the value conversion unit 18 and the value conversion unit 19, values are converted to a format different from those of 1/0 data and variable-type data.

Thus, in the operation verification system 60 and the operation verification device 50 according to embodiment 2, the formats of a node value and an internal state value are matched with each other, whereby it becomes easier for the comparison unit 12 to output a match rate between the node value and the internal state value. Thus, it becomes easier to prescribe an error range that depends on structural difference between the circuit 2 and the simulator 7 and allow perfect match and match within the error range to be selectively obtained.

As described above, in the operation verification system 60 and the operation verification device 50 according to embodiment 2, the comparison unit 12 performs comparison using values after conversion according to a format of at least one of a node value of the FPGA 1 and an internal state value when the simulator 7 is operated. Thus, the same effects as in the operation verification system 60 and the operation verification device 50 according to embodiment 1 are provided, and further, comparison between the node value and the internal state value can be performed with high accuracy. In addition, the comparison unit 12 in the operation verification system 60 and the operation verification device 50 according to embodiment 2 outputs a match rate between the node value and the internal state value. Thus, it is possible to easily confirm a verification result using a specific match rate.

### Embodiment 3

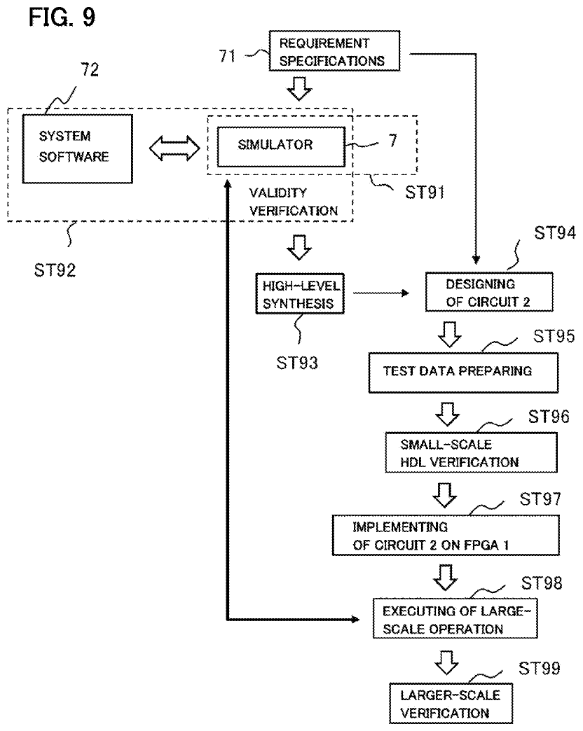

An operation verification system 60 and an operation verification device 50 according to embodiment 3 are examples configured as a co-design system. FIG. 9 is a flow diagram showing a co-design system using the operation verification system and the operation verification device according to embodiment 3. The operation verification system 60 and the operation verification device 50 according to embodiment 3 include the simulator 7 verified by the co-design system, and the FPGA 1 having the circuit 2 designed on the basis of high-level synthesis according to the verification result for the simulator 7 and requirement specifications 71. Hereinafter, the operation verification system 60 and the operation verification device 50 according to embodiment 3 will be described with reference to FIG. 9. The operation verification system 60 and the operation verification device 50 according to embodiment 3 have configurations similar to those of the operation verification system 60 and the operation verification device 50 according to embodiments 1 and 2. Description of the same parts between embodiment 3 and embodiments 1 and 2 is omitted. In the drawings, the same reference characters denote the same or corresponding parts and the detailed description thereof is omitted.

First, a background behind the fact that the operation verification system 60 and the operation verification device 50 are advantageous will be described. In development of a semiconductor circuit, in general, after a hardware configuration is determined, software specifications are determined and then development is started. In evaluation for these, evaluation for software cannot be advanced unless hardware including large-scale integration (LSI) becomes operable in the first place.

In general, personnel involved in development include software developers as a majority. Therefore, malfunction in development of hardware leads to, for example, making many software development personnel wait or necessitating change, thus having a great influence on the entire product development. On the other hand, malfunction in software development has a less influence on hardware development. Because of such a relationship, the hardware development quality is naturally required to have higher accuracy than the software development quality. In a case where LSI development accompanied with circuit designing is included in hardware development, the difficulty in maintaining the quality becomes higher, so that how to enhance the LSI development quality becomes an important problem.

Accordingly, the co-design system shown in FIG. 9 is advantageous. That is, the simulator 7 described thus far can be used as a measure for how to suppress and exclude misunderstanding or failure of circuit designers.

Next, flow of designing and verification for the circuit 2 using the co-design system shown in FIG. 9 will be described. In step ST91, the simulator 7 is designed on the basis of the requirement specifications 71. In step ST92, the simulator 7 and the system software 72 are compared, to verify validity. In step ST93, a specific design is determined from the requirement specifications 71 on the basis of the verification result, to perform high-level synthesis into the design of the circuit 2. In step ST94, the circuit 2 is designed on the basis of the requirement specifications 71 and the high-level synthesis using the verification result of the simulator 7. That is, a specific function design is definitely determined through steps ST91 to ST93, and then designing of the circuit 2 is performed.

Then, in step ST95, test data for implementing the circuit 2 on the FPGA 1 is prepared. In step ST96, with this test data, HDL simulation is performed. In the HDL simulation in step ST96, small-scale verification is performed and this is not large-scale verification performed in the HDL simulation described as a problem in the present disclosure. In step ST97, with the result of step ST96 reflected, the circuit 2 is implemented on the FPGA 1. The subsequent step ST98 and step ST99 are performed by operation of the operation verification system 60 or the operation verification device 50.

In step ST98, the control unit 10 operates the circuit 2 and the simulator 7 by the operation instruction unit 11. In step ST99, the control unit 10 compares a node value when the circuit 2 is operated and an internal state value corresponding to the node value, by the comparison unit 12, to verify operation of the FPGA 1. In step ST98 and step ST99, verification by the operation verification system 60 or the operation verification device 50 is performed and this is larger-scale verification as compared to the verification in step ST96. Here, the operation instruction unit 11 operates the circuit 2 and the simulator 7 at the same time.

Thus, the co-design system shown in FIG. 9 is based on the following concept: if the entire process is executed on the basis of only an idea in one's mind and then is confirmed at the final stage, misunderstanding remains until the final step of designing, but if the idea in one's mind is embodied as an actual form to perform confirmation at an early stage, misunderstanding is detected, so that a loop of process return is reduced. For construction of the operation verification system 60 or the operation verification device 50, creating the simulator 7 of software is by far easier than implementation using HDL, and is suitable for early confirmation in advance. As a matter of course, what is implemented using HDL is not small-scale verification as in step ST96 but large-scale verification as in step ST98 and step ST99.

In the operation verification system 60 and the operation verification device 50, the control unit 10 may indicate a comparison result of the comparison unit 12 or an execution status, using a display or the like. For example, two kinds of log files are generated in a text format, in every verification. As for image data, the following example is conceivable. In a case of indicating a comparison result, only jpg photographs for which mismatch has been found in comparison are displayed and the details of the mismatch are also displayed together in an easily understandable manner. If there is no mismatch in all jpg photographs, an indication “nn jpg Mismatch Zero” is displayed. Here, nn denotes the number of jpg photographs subjected to a test. In a case of indicating an execution status, for which jpg photographs and to which layer the process has been executed, a comparison result for each layer, and OK/NG (good/fault) as a final inference result, are displayed. In this way, whether or not there is a problem with each jpg photograph can be found by just looking.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to another embodiment or another implementation of the disclosure. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another embodiment or another implementation.

### DESCRIPTION OF THE REFERENCE CHARACTERS

1 FPGA
2 circuit
3 internal RAM
4 bus circuit
5 external memory
6 computer
7 simulator
8 system memory
9 communication path
10 control unit
11 operation instruction unit
12 comparison unit
13 processing phase management unit
14 simulator control unit
15 system memory access unit
16 FPGA control unit
17 FPGA-side memory access unit
18 value conversion unit
19 value conversion unit

1. An operation verification system comprising:
an FPGA having a circuit programmed therein;
an internal RAM of the FPGA;
a bus circuit interposed for transmission and reception of data between the internal RAM and outside;
an external memory of the FPGA in which a node value of the FPGA is written from the internal RAM via the bus circuit;
a computer having installed therein a simulator which simulates the circuit; and
a communication path connecting the FPGA and the computer via the bus circuit, wherein
the computer includes a system memory in which an internal state value when the simulator is operated is written, and a control unit which controls the FPGA via the communication path,
the control unit includes an operation instruction unit for operating the circuit and the simulator, and a comparison unit which compares the node value when the circuit is operated, obtained from the external memory and the internal state value corresponding to the node value, to verify operation of the FPGA, and
the operation instruction unit operates the circuit and the simulator at the same time.

2. The operation verification system according to claim 1, wherein
the comparison unit compares the node value and the internal state value on a memory basis between the external memory and the system memory.

3. The operation verification system according to claim 1, wherein
the comparison unit compares the node value and the internal state value between files outputted from the system memory and the external memory.

4. The operation verification system according to claim 1, wherein
the comparison unit compares the node value that is designated and the corresponding internal state value.

5. The operation verification system according to claim 1, wherein
the comparison unit performs comparison using values after conversion according to a format of at least one of the node value or the internal state value.

6. The operation verification system according to claim 1, wherein
the comparison unit outputs a match rate between the node value and the internal state value.

7. An operation verification device for verifying operation of an FPGA having a circuit programmed therein, the operation verification device comprising a computer having installed therein a simulator which simulates the circuit, wherein
the computer includes a system memory in which an internal state value when the simulator is operated is written, and a control unit which controls the FPGA via a communication path connecting the FPGA and the computer via a bus circuit interposed for transmission and reception of data between an internal RAM of the FPGA and outside,
the control unit includes an operation instruction unit for operating the circuit and the simulator, and a comparison unit which compares a node value of the FPGA when the circuit is operated, obtained from an external memory of the FPGA in which the node value is written from the internal RAM via the bus circuit, and the internal state value corresponding to the node value, to verify operation of the FPGA, and
the operation instruction unit operates the circuit and the simulator at the same time.

8. The operation verification device according to claim 7, wherein
the comparison unit compares the node value and the internal state value on a memory basis between the external memory and the system memory.

9. The operation verification device according to claim 7, wherein the comparison unit compares the node value and the internal state value between files outputted from the system memory and the external memory.

10. The operation verification device according to claim 7, wherein
the comparison unit compares the node value that is designated and the corresponding internal state value.

11. The operation verification device according to claim 7, wherein
the comparison unit performs comparison using values after conversion according to a format of at least one of the node value or the internal state value.

12. The operation verification device according to claim 7, wherein
the comparison unit outputs a match rate between the node value and the internal state value.

13. The operation verification system according to claim 2, wherein
the comparison unit compares the node value that is designated and the corresponding internal state value.

14. The operation verification system according to claim 3, wherein
the comparison unit compares the node value that is designated and the corresponding internal state value.

15. The operation verification system according to claim 2, wherein
the comparison unit performs comparison using values after conversion according to a format of at least one of the node value or the internal state value.

16. The operation verification system according to claim 3, wherein
the comparison unit performs comparison using values after conversion according to a format of at least one of the node value or the internal state value.

17. The operation verification device according to claim 8, wherein
the comparison unit compares the node value that is designated and the corresponding internal state value.

18. The operation verification device according to claim 9, wherein
the comparison unit compares the node value that is designated and the corresponding internal state value.

19. The operation verification device according to claim 8, wherein
the comparison unit performs comparison using values after conversion according to a format of at least one of the node value or the internal state value.

20. The operation verification device according to claim 9 wherein
the comparison unit performs comparison using values after conversion according to a format of at least one of the node value or the internal state value.
